(19) United States
(12) Patent Application Publication
(10) Pub. No.: US 2015/0048702 A1
(43) Pub. Date: Feb. 19, 2015

(54) NON-CONTACT TYPE POWER GENERATOR

(71) Applicant: Shun-Fu Technology Corp., Taipei City (TW)

(72) Inventors: Yung-Sheng HUANG, Taipei City (TW); Shun-Hua LEE, Taipei City (TW)

(73) Assignee: Shun-Fu Technology Corp., Taipei City (TW)

(21) Appl. No.: 13/967,671

(22) Filed: Aug. 15, 2013

(51) Int. Cl. H02K 49/10; H02K 1/27

(52) U.S. Cl. CPC H02K 49/10; H02K 1/2706
USPC 310/103

(57) ABSTRACT

A non-contact type power generator includes at least one metal element continuously rotated by force generated by an outer device; at lest one magnetic rotor disposed near the metal element without contact and rotated with respect to an axis by the metal element; and a coil disposed around the magnetic rotor. The metal element rotates continuously to rotate the magnetic rotor to cut the magnetic line generated by the coil to generate induced power for other devices.

### BACKGROUND OF THE INVENTION

1. Field of the Invention

The present invention relates to a power generator, and in particular to a non-contact type power generator disposed in an outer device capable of continuously rotating the non-contact type power generator to generate induced power.

2. Description of the Related Art

Based on the Fleming's left hand rule, the thumb, the forefinger and the middle finger are stretched and perpendicular to one another to represent force exerted on a conductive object, magnetic field direction (from N pole to S pole) and current direction through the conductive object respectively. The Fleming's left hand rule is also named electrical motor rule.

FIG. 1 depicts a typical electrical motor 10 governed by the Fleming's left hand rule. One of two opposite disposed magnetic elements 11 and 12 has its N pole corresponding to the other's S pole, and a coil 13 is disposed between the magnetic elements 11 and 12. When the coil 13 rotates to cut the magnetic lines from the N pole to the S pole, an electromotive force (emf) is generated. According to Fleming's left hand rule, the forefinger represents the magnetic field M (from N pole to S pole), the middle finger represents the direction of current I through the conductive object and the thumb represents the force F exerted on the conductive object, wherein the current I flows along the directions shown by arrows a and b.

In such electrical motors, the coil 13 is rotated by related elements such as teeth joint elements, chains or propellers by a “direct contact” way to generate induced current, i.e. the typical electrical motor 10 must be directly connected or contacted to a driving source. Therefore, the application of such electrical motor is highly limited.

### SUMMARY OF THE INVENTION

It is one object of the present invention to provide a non-contact type power generator generating induced power by means of a non-contact structure to broaden the applicable category.

To achieve this object of the present invention, one embodiment of a non-contact type power generator of the invention includes at least one metal element continuously rotated by force generated by an outer device; at lest one magnetic rotor disposed near the metal element without contact and rotated with respect to an axis by the metal element; and a coil disposed around the magnetic rotor. The metal element rotates continuously to rotate the magnetic rotor to cut the magnetic line generated by the coil to generate induced power for other devices.

In one embodiment of the present invention, the outer device is a moving vehicle and in particular a metal wheel rim serving as a dynamic metal element or steel rails or steel cables serving as a static metal element.

In one embodiment of the present invention, the magnetic rotor includes a plurality of magnetic sheets joined together, and centers of magnetic sheets overlaps to constitute the axis.

In one embodiment of the present invention, the non-contact type power generator includes a plurality of sub-coils serially connected to increase voltage.

In one embodiment of the present invention, the non-contact type power generator includes a plurality of coils parallel connected to increase current.

In one embodiment of the present invention, the magnetic rotor and the coil are coupled to a circuit board by a wire to drive a power consuming device.

In one embodiment of the present invention, the circuit board sends power to the power consuming device via a stabilizing-driving circuit.

In one embodiment of the present invention, the magnetic rotor and the coil are coupled to a circuit board by a wire and disposed in a housing which is fixed to the outer device by a frame.

In one embodiment of the present invention, the outer device is a hydraulic device driving the metal element.

### BRIEF DESCRIPTION OF THE DRAWINGS

FIG. 1 depicts a typical electrical motor governed by the

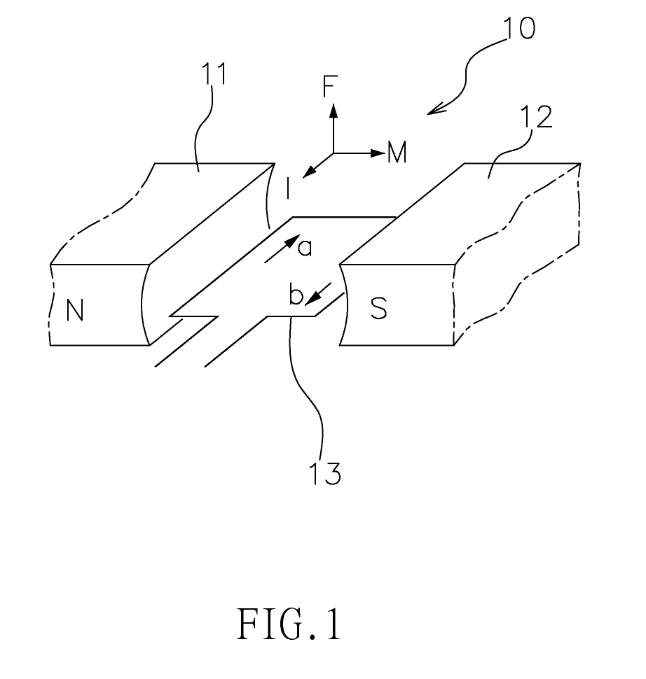

Fleming's left hand rule;

FIG. 2 depicts an embodiment of a non-contact type power generator of the present invention;

FIG. 3 is a cross section of FIG. 2;

FIG. 4 depicts the non-contact type power generator of the present invention applied to a vehicle; and

FIG. 5 is a flow chart of FIG. 4.

### DETAILED DESCRIPTION OF THE PREFERRED EMBODIMENT

The invention is detailed described by the following embodiment in accompany with drawings,

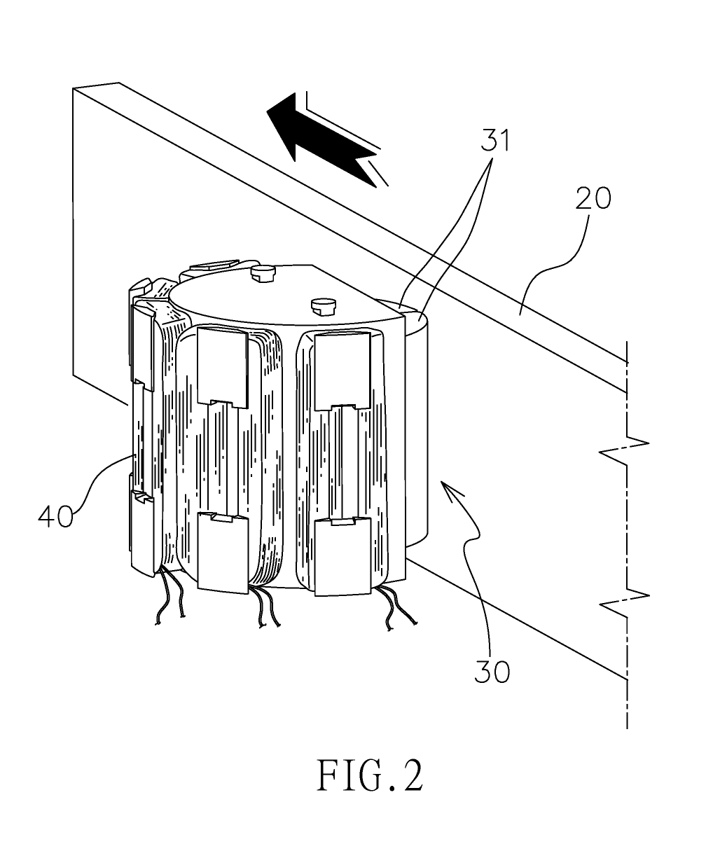

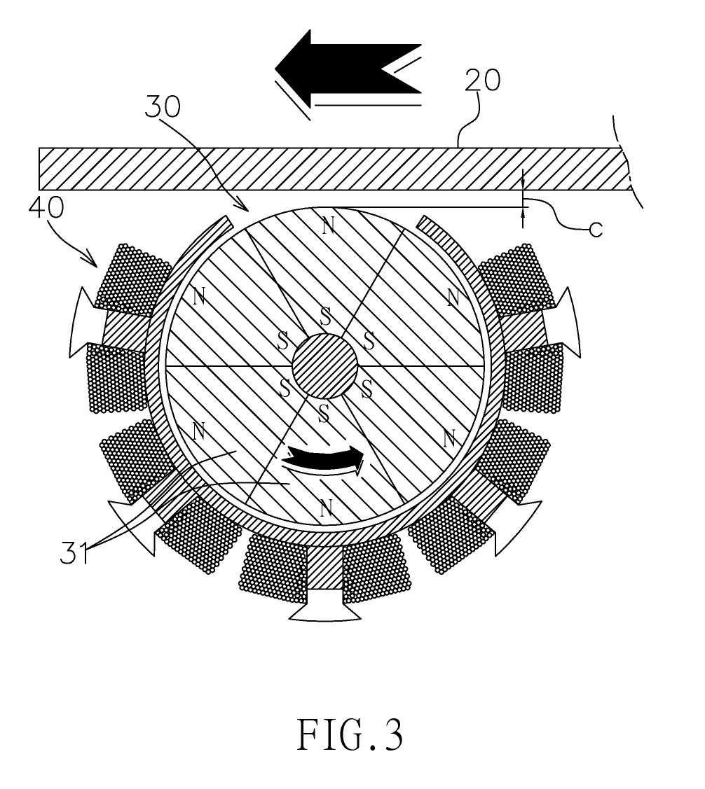

Referring to FIGS. 2 and 3, the non-contact type power generator of the invention includes at least one movable metal element 20 which is rotated in a direction (shown by an arrow) by force generated by an outer device such as a metal wheel rim of a moving vehicle like locomotive, automobile, motorbike or bicycle, which serves as a dynamic metal element 20. In another embodiment of the invention, the metal element 20 can be a static supporting element such as steel rails for trains or steel cables for cable cars, which serves as one corresponding element with magnetic effect and movement relative to the other corresponding element.

A magnetic rotor 30 serving as the other corresponding element is disposed near the movable metal element 20 without contacting the metal element 20 and rotates continuously with respect to an axis. A coil 40 is disposed around the magnetic rotor 30. The coil 30 can be winded around a magnet conductive object such as iron sheets, silicon steel sheets or ferrite core to increase induced voltage.

Referring to FIG. 3, the magnetic rotor 30 includes several magnetic sheets 31. The magnetic sheets 31 are joined to one another to form the magnetic rotor 30. The magnetic sheets 31 are preferred to be permanent magnets. In this embodiment, the magnetic sheets 31 have sector shapes.

Referring to FIG. 3, the magnetic rotor 30 disposed near the metal element 20 without contact and is spaced from the metal element 20 by a gap c which must be as small as possible to generate the largest magnetic attracting force and the highest rotational speed to obtain the largest induced power.

The magnetic rotor 30 is rotatablely connected to a shaft at its center, and is rotated with respect to an axis extending through the center. The rotatable structure is used only for description but not limited thereto.

When the metal element 20 rotates continuously (such as a vehicle in traffic), the magnetic rotor 30 is continuously rotated by the attractive force generated between the metal element 20 and the magnetic rotor 30 to cut the magnetic lines generated by the coil 40 to generate induce power. The magnetic rotor and coils are possibly disposed in a vehicle in traffic (trains or cable cars) to move relative to static supporting elements (steel rails or steel cables) to generate electrical power.

The voltage and current generated by the magnetic element 30 cutting the magnetic lines depend on the following factors.
a. The magnitude of magnetic force from the magnetic rotor 30 made of strong permanent magnetic material and the polarity length of the N pole and the S pole of magnets.
b. The length of winding coil determines the magnitude of the electromotive force (voltage), and therefore serial connection of several coils increases voltage.
c. The number of magnetic lines being cut determines the magnitude of induced current, and therefore parallel connection of several coils increases current.

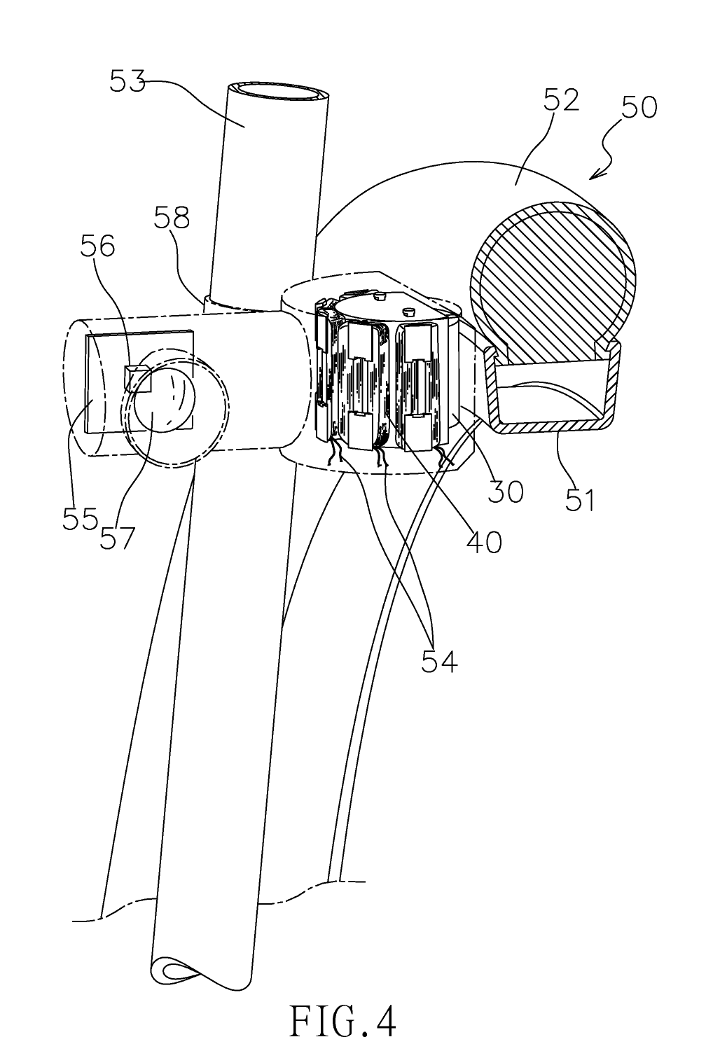

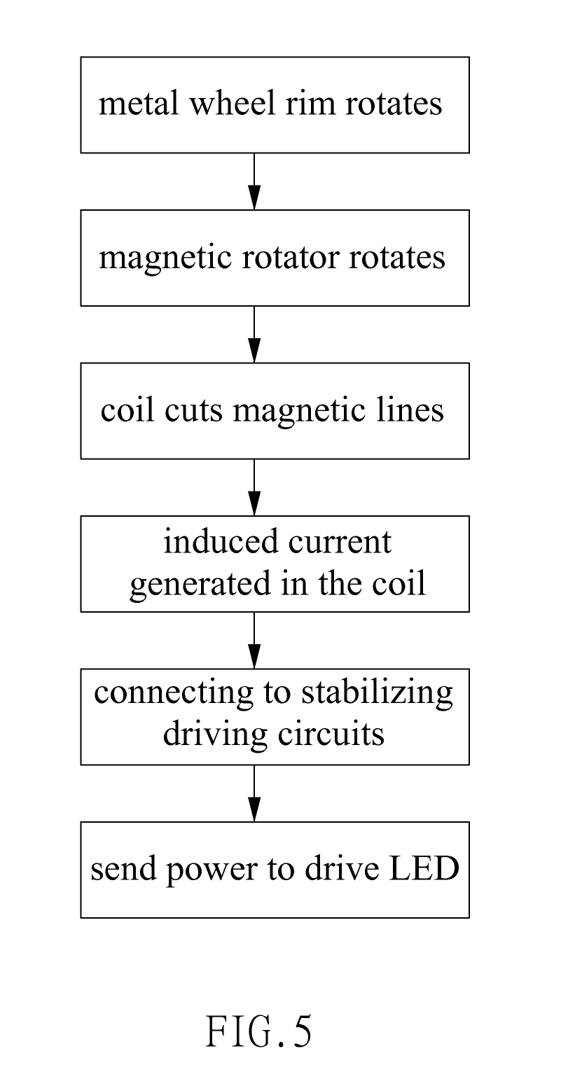

Referring to FIGS. 4 and 5, a metal wheel rim 51 of a wheel 50 serves as the movable metal element 20. A tire 52 is disposed around the metal wheel rim 51 which is disposed on a chassis 53. The magnetic rotor 30 and the coil 40 are spaced from the metal element 20 by a smallest gap. The induced current generated by the magnetic rotor 30 and the coil 40 flows to circuit board 55 via a wire 54 to drive a power consumption device (such as LED 56). In this embodiment, the LED 56 is disposed behind a lens 57. AT the same time, the entire power generator and related parts can be disposed in a housing and fixed to the chassis 53 by a frame 58.

Referring to FIG. 5, when the metal wheel rim 51 is continuously rotated by the vehicle in traffic, the magnetic rotator 30 is rotated by the attractive force between the metal wheel rim 51 and the magnetic rotor 30 to cut the magnetic lines to generate induced current. The induced current (power) is sent to the LED via a stabilizing-driving circuit.

Although the outer device is a vehicle in this embodiment, it is not limited thereto. Other devices such as a hydraulic device can also serve as the outer device to rotate or move the metal element 20.

Since the power generator of the invention is disposed in various devices by a non-contact structure, it can be broadly applied to various equipments.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A non-contact type power generator, comprising:
at least one metal element serving as one corresponding element moved by an outer device;
at lest one magnetic rotor serving as the other corresponding element, moving relative to the metal element and disposed near the metal element without contact and continuously rotated by the movement relative to the metal element; and
at least one coil disposed around the magnetic rotor to cut magnetic lines.

2. The non-contact type power generator as claimed in claim 1, wherein the outer device is a vehicle.

3. The non-contact type power generator as claimed in claim 1, wherein the metal element is a dynamic metal part of the vehicle.

4. The non-contact type power generator as claimed in claim 3, wherein the metal element is a metal wheel rim of the vehicle.

5. The non-contact type power generator as claimed in claim 3, wherein the metal element is a static metal supporting element for the vehicle.

6. The non-contact type power generator as claimed in claim 5, wherein the metal element is a steel rail for the vehicle.

7. The non-contact type power generator as claimed in claim 5, wherein the metal element is a steel cable for the vehicle.

8. The non-contact type power generator as claimed in claim 1, wherein the magnetic rotor comprises a plurality of magnetic sheets joined together, and centers of the magnetic sheets overlaps to constitute the axis.

9. The non-contact type power generator as claimed in claim 1 comprising a plurality of coils serially connected to increase voltage.

10. The non-contact type power generator as claimed in claim 1 comprising a plurality of coils parallel connected to increase current.

11. The non-contact type power generator as claimed in claim 1, wherein the magnetic rotor and the coil are coupled to a circuit board by a wire to drive a power consuming device.

12. The non-contact type power generator as claimed in claim 7, wherein the circuit board sends power to the power consuming device via a stabilizing-driving circuit.

13. The non-contact type power generator as claimed in claim 7, wherein the magnetic rotor and the coil are coupled to a circuit board by a wire and disposed in a housing which is fixed to the outer device by a frame.

14. The non-contact type power generator as claimed in claim 1, wherein the outer device is a hydraulic device driving the metal element.
